(19) United States
(12) Patent Application Publication
(10) Pub. No.: US 2006/0148914 A1
(43) Pub. Date: Jul. 6, 2006

(54) Methods and compositions for decolorizing thermoplastics and articles made using such decolorized thermoplastics

(76) Inventors: Daniel Martin Connor, Inman, SC (US); Keith Alan Keller, Spartanburg, SC (US)

Correspondence Address: Legal Department;Milliken & Company, M-495, 920 Milliken Road, P.O. Box 1926, Spartanburg, SC, 29304, US

(21) Appl. No.: 11/028,708

(22) Filed: Jan. 4, 2005

(51) Int. Cl. C08J 11/04; C08L 67/00

(52) U.S. Cl. 521/48; 524/601

(57) ABSTRACT

The invention relates to the use of chemical compositions useful for decolorizing recycle thermoplastics such as oxidizing agents, reducing agents, or photo-initiators combined into thermoplastics such as polypropylene (PP), polyethylene terephthalate (PET), polybutylene terephthalate (PBT), polycarbonates (PC), polyethylene (PE), polylactic acid (PLA), nylon, PET copolymers, acrylics, Surlyn™, or other thermoplastics. In one example, a radical initiator of a peroxide-containing compound assists in achieving decolorization of thermoplastics. The decolorizing process may increase the value of plastics for purposes of recycling.

### BACKGROUND OF THE INVENTION

Thermoplastic articles are useful for a wide variety of applications. Furthermore, the recycling of colored thermoplastic articles is even more important than ever before, as the volume of thermoplastics and plastics discarded in the United States has proliferated in the last few decades.

Polyethylene terephthalate (PET) has been widely employed in the manufacture of packaging items. One large volume application for PET is in the manufacture of food packaging items. PET is used extensively for beverage bottles, including bottles for carbonated soft drinks and other liquids. Many of the articles used in this way are colored by various types of pigments or colorants to enhance their appearance or to protect the contents of the bottle from ultraviolet radiation.

Recycled PET is used in the manufacture of products such as carpeting, strapping, textiles, beverage bottles, and insulation. The value of recycled colored PET is much less than PET, which is not colored or only slightly colored. Uncolored PET may be applied in many different recycled product applications, while a relatively heavily colored PET has limited value in recycle applications. There is a great need in the recycling industry for better methods and techniques for removing colorants from recyclable thermoplastics, such as PET or polybutylene terephthalate (PBT), polypropylene (PP), polyethylene (PE), polylactic acid (PLA), polyethylene naphthalate (PEN), nylon, and others.

Other polymers, which have significant recycling value, include PE (such as used milk jugs for example) and PP. There exists a current and strong future need to remove the coloration from many types of thermoplastics.

One published UK patent application, GB 2 371 310 A, is directed to bleaching compositions of radical initiators. This patent is directed to laundry treatment compositions for spot treatment of soiled articles and to a process for using such compositions. Furthermore, other literature has been published relating to decolorization of inks with paper. See, for example U.S. Pat. No. 6,017,386.

In WO 2004/020519A1, Rule et al. teach the use of polymethylhydrosiloxane (PMHS) and other reactive hydrogen sources for the reduction of acetaldehyde (M) in PET. No mention is made of the destruction of chromophores or the reduction of any colored species, nor is any such application envisioned.

Another reference, European patent application EP 1 411 078 A1 is directed to the recycling of colored thermoplastic molded articles. In that disclosure, a colorant additive composition is added to a thermoplastic molding composition, which may be a polyester such as PET. The colorant additive composition comprises a thermolabile sublimable colorant. Thus, the colorant additive composition may be applied into a thermoplastic molding composition for making bottles, which then can be recycled by a recycling process that includes a step of subjecting the recycled material to elevated temperature conditions. The elevated temperature causes a desirable change of color in the material by the extraction of at least some of the thermolabile sublimable colorant from the thermoplastic.

There are significant disadvantages to the employment of a sublimable colorant. For example, it sometimes is difficult to control the sublimation of the colorant from the thermoplastic at only one discrete recycling step. There are high temperature steps involved in manufacturing, and sometimes in filling a container. Such high temperature steps may undesirably result in the sublimation of colorant from the thermoplastic at the wrong place in the process stream.

In the manufacture of containers from PET it is common for PET pellets to be heated at relatively high temperature in a solid-state reactor. Relative high molecular weight pellets of PET may be produced as a result, and volatile colorants would clearly be unsuited for this application. PET is commonly oven dried prior to use, the elevated temperatures may lead to contamination of equipment or loss of color. In a later step, these pellets may be injection molded into preforms. During this preform manufacturing step, it is common for a colorant to be added. One disadvantage of using a sublimable type colorant is that it such a colorant may migrate out of the thermoplastic during the injection-molding step. Furthermore, such sublimable colorants could undesirably volatilize during the step of blow molding to preform into a container. A plate-out or volatilization of sublimable colorants at this step would be highly undesirable. If that occurs, the colorant may clog or gum the equipment, especially in high volume manufacturing operations.

A thermoplastic that is to be recycled typically is washed, flaked or pelletized, and then supplied to a solid-state reactor in the process of converting waste plastic into recyclable articles. The heating of recyclable plastic containing sublimable colorants could undesirably result in the deposition of such colorants in the solid-state reactor. For these reasons, and perhaps others, there are significant disadvantages to the use of sublimable colorants.

Several attempts have been made to remove color from colored plastic such as textile materials. These attempts, such as in U.S. Pat. No. 6,036,726 and U.S. Pat. No. 4,720,540, use organic solvents to dissolve or swell the polymer for dye extraction. These procedures are costly and often environmentally unacceptable. In general, it is believed that these processes do not suggest adding a decolorizing agent to a polymer melt.

JP2004269602A discloses the use of oxidants such at hydrogen peroxide and reducing agents such as thiourea dioxide in a process whereby the surface of the polymer is contacted by an aqueous solution of oxidant or reductant. The stated purpose of such agents is to reduce the unwanted yellow tint caused by titanium catalyzed resin production. This approach is limited, however, in part because the penetration effect of aqueous solutions into polymers (such as PET and polyolefins) is slow and limited.

In Polymer Preprints: “Color Generation in Polyester/Polyamide Blends” 2004, 45(1), 992, an approach is disclosed for mediating color formation caused by degradation or by-products during the blending of aromatic polyamide and PET. Sodium borohydride is added to the reactor to eliminate the yellow by-product.

The synthesis of inorganic peroxides such as silicon peroxides have been disclosed, J. Org. Chem, 1965, 2417. The use of inorganic peroxides such as silicon peroxides in polymers has been limited to the use of these materials as polymerization initiators in polymer synthesis. Colombani et al. discloses the use of silyl peroxides to initiate the polymerization of styrene and acrylate polymers, J. Polym. Sci, Part A: Polymer Chemistry, 34,1996, 893. GB 827,366 discloses the use of silyl, germanyl, and titanyl peroxides to initiate the polymerization of methyl acrylate. U.S. Pat. No. 3,450,686 discloses the use of silyl peroxides to initiate the polymerization of ethylene. U.S. Pat. No. 4,161,485 discloses the sue of silyl peroxides as catalysts for curing unsaturated polyesters.

It is believed that the prior art has not recognized the opportunity to use inorganic or specifically silyl peroxides in the polymer melt to modify the polymer or modify compounds mixed with the polymer after the polymer is made. By the term inorganic peroxides, it is meant a peroxide structure where at least one of the oxygens of the peroxide unit is bonded to an element other than carbon or hydrogen.

### BRIEF DESCRIPTION OF THE DRAWINGS

A full and enabling disclosure of this invention, including the best mode shown to one of ordinary skill in the art, is set forth in this specification. The following Figures illustrates the invention:

FIG. 1 shows an extruder mechanism that may be employed in one embodiment of the invention; and

FIG. 2 illustrates schematically one manner of practicing the invention; and

FIG. 3 reveals a simplified scheme that represents one manner of the practicing the invention.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

The invention relates to the use of chemical compositions such as strong oxidizing agents, reducing agents, photo-initiators, or other such compounds combined into thermoplastics such as for example polypropylene (PP), polyethylene terephthalate (PET), polybutylene terephthalate (PBT), polycarbonates (PC), polyethylene (PE), polylactic acid (PLA), nylon, PET copolymers, acrylics, Surlyn™, polyethylene naphthalate (PEN), and other thermoplastics.

In one embodiment of the invention a radical initiator may assist in achieving decolorization of thermoplastics. The decolorizing process may increase the value of such plastics for purposes of recycling. In another embodiment of the invention, a reducing agent such as a hydride or hydrogen atom source assists in achieving the decolorization. In yet another embodiment of the invention, a photo-initiator combined with light exposure assists in achieving decolorization.

The invention may be employed for removal of color from PET, as one example. Currently, multi-colored plastic bottles and the like are not easily or cost effectively recyclable because in part it is not economically viable to do so. Coloring agents present in waste bottles to be recycled causes the recycling value of such bottles to be quite low. The invention relates to methods and compositions useful for decolorizing thermoplastic material to increase the economic value of such materials.

The decolorized thermoplastic made according to the invention may be used in making containers or bottles, in which the total recycle content in such bottles may be quite low, or relatively high, depending upon the application. Thus, one embodiment of the invention involved the manufacture of an article (fiber container, bottle, or other device) using at least some content that is recycled thermoplastic that has been substantially decolorized.

Decolorizing Apparatus and Techniques

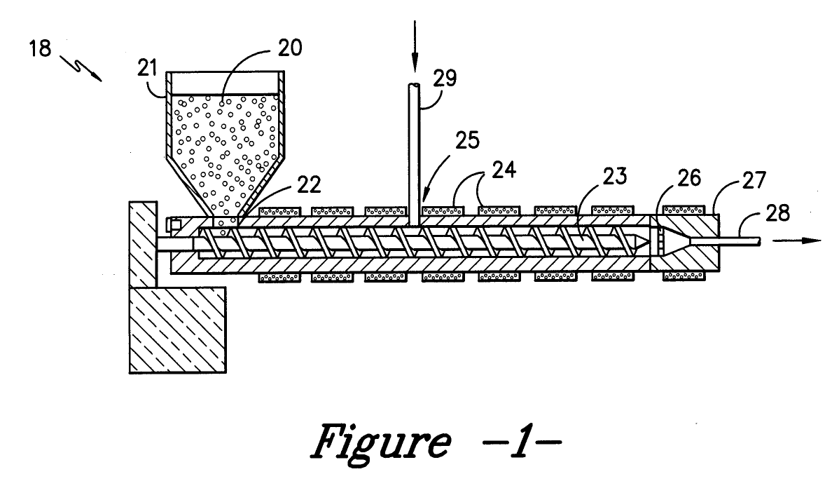

With reference to FIG. 1, an extruder 18 is shown with a hopper 21 near the left side and a die 27 near the right side. In the recycling of thermoplastics, thermoplastic material 20 is added to the hopper 21. This thermoplastic could be in the form of colored polymer flake or pellets that result from the shredding or destruction of used and discarded container articles, for example. These colored polymer flakes or pellets 20 are fed mechanically through hopper 21 to barrel 22 of extruder 18. Pellets 20 are heated and melted within barrel 22. The screw 23 feeds the molten polymer. Heaters 24 are shown in FIG. 1. They provide thermal energy to melt the pellets 20 as they travel along the barrel 22, becoming a flowable liquid. When the pellets 20 become molten polymer, they pass through screen 26. The molten polymer passes into die 27, and exits as polymer 28. Polymer 28 has reduced levels of color compared to the colored pellets 20.

In this specification, it is assumed that semi-crystalline polymers are melt processed at or above their melting points and that amorphous polymers are melt processed above their glass transition temperatures. The melt processing temperature is defined as the minimum temperature, at which a thermoplastic can be melt processed on a plastic extruder such as that shown in FIG. 1.

In the practice of the invention, there are at least two techniques by which a decolorizing additive may be added into a colored polymer. First, a decolorizing additive may be added directly into hopper 21, and such additive may be mechanically mixed with the colored polymer pellets 20 (or flakes) prior to extrusion. In that instance, the decolorizing additive may be melted with the colored polymer (i.e., “added to the melt”). The polymer 28 exits the extruder 18 as a substantially decolorized mixture. The additive can also be added to the hopper by way of a masterbatch, which is a mixture of decolorizing additive with polymer, the mixture being a highly concentrated amount of decolorizing additive relative to the polymer. For purposes of this disclosure, decolorization “additive” and decolorization “agent” refer to essentially the same composition, and these terms are used interchangeably herein.

A second method or technique that may be employed in the practice of the invention is the application of a decolorizing additive through an optional liquid line 29, which may be provided for injection at injection point 25, shown in FIG. 1. In this instance, the decolorizing additive may be added in liquid form to the colored polymer as it passes through the barrel 22 shown in FIG. 1. Thus, the optional liquid line 29 may or may not be used, and is shown in FIG. 1 as an optional feature.

The decolorizing agent could comprise a solid, a powdered solid, a masterbatch, a solid dispersion, or a liquid. The invention is not limited to any particular physical form of the decolorizing agent. Furthermore, the invention is not limited to the application of decolorizing additive at any particular point in the process. However, it has been found that the invention works well when the decolorizing additive is added in extruder 18. The total amount of time needed in the mixing step of mixing the decolorization agent with the thermoplastic no more than a few minutes or seconds, in most instances.

Furthermore, it would be possible to provide a decolorizing additive both in the hopper and by way of liquid line 29. Thus, FIG. 1 is generically provided to show what could be accomplished in any of several mechanical application techniques, and it is understood that the extruder in the practice of the invention may or may not include the liquid line 29.

Although FIG. 1 is directed to a cross-sectional view of an extruder 18, it should be recognized that the practice of the invention is not limited to extruders. For example, the invention could be practiced using other apparatus such as melt pumps, calendering equipment, reactors, static mixers, and perhaps other mechanisms known in the art. FIG. 1 is shown as an illustration of one practice of the invention, but is not limiting to the scope of the invention. Furthermore, a secondary treatment may be necessary to activate the decolorizing agent such as UV light exposure or heating in solid form for a set period of time. One example of this post-extrusion heating step could be the solid-stating process.

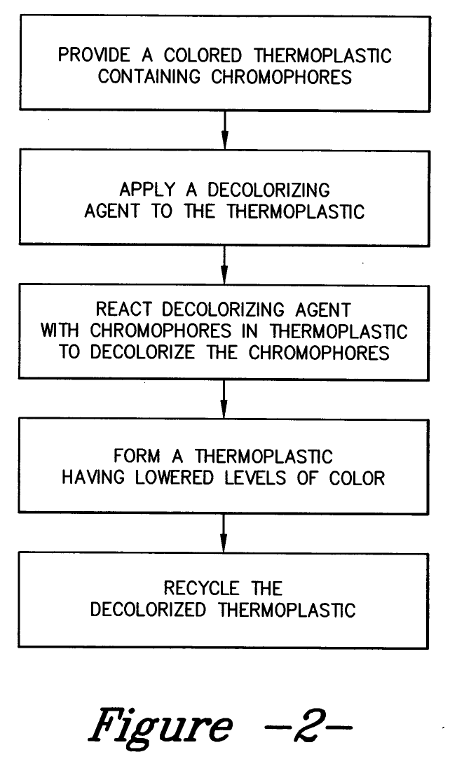

FIG. 2 illustrates the basic sequence of events in one practice of the invention. First, a colored thermoplastic containing chromophores is provided. A decolorization agent is applied to the thermoplastic. The decolorizing agent reacts with chromophores in the thermoplastic to decolorize the chromophores. Examples of chromophores that may be decolorized are azo compounds, methines, triphenylmethanes, anthraquinones, squaranes, benzodifuranones, metal complexes such as copper phthalocyanines, and the like. This process forms a substantially decolorized thermoplastic, or at a minimum a thermoplastic with reduced color levels or intensity compared to the original thermoplastic. The thermoplastic having reduced color levels is more amenable to recycling than the original thermoplastic, and may have enhanced value in the marketplace. Reduced color levels or intensity is intended to include the removal of one color in a mixture of colors to give a more desirable shade. In one, non-limiting example, the yellow component of a green mixture could be removed, leaving a more desired blue shade. A reduction of color intensity means changing the visual appearance of the plastic so that it appears more lightly colored. For example, conversion of a red to a ping, or a dark green to a light green, or green to light blue, etc.

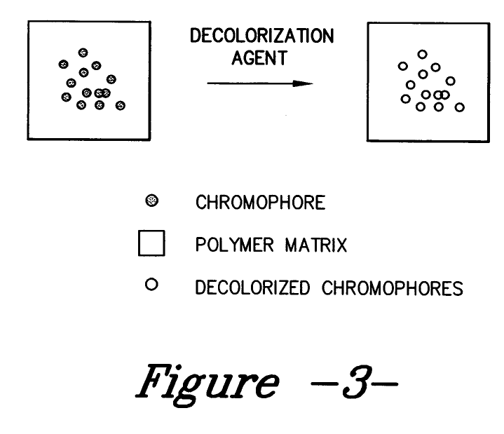

FIG. 3 shows schematically the practice of the invention.

### Decolorizing Additives (Acients)

In the practice of the invention, a decolorizing additive (“agent”) is applied to a colored polymer in a manner whereby the chromophore of the colored polymer is altered such that the colored polymer is rendered substantially colorless (or at least at a reduced level of color intensity). This method may be achieved using a wide variety of chemical compositions, some of which are listed herein. Some decolorizing agents are oxidizing agents, some may be reducing agents, and some may be operate by photochemical radical initiation, as further discussed below.

Oxidation in chemistry is generally defined as the loss of electrons in the portion of the molecule at issue. Reduction is generally defined as the gain of electrons to the portion of the molecule at issue. The convention is to set-up tables of functional group transformations. Oxidation is the conversion of a functional group from one category to a higher one. Reduction is the conversion of one functional group to a lower one on the table. Most oxidations in organic chemistry involve a gain of oxygen or a loss of hydrogen. The reverse is typically true for reductions. Common examples of oxidation reactions are conversions such as alkanes to alkenes, alkenes to alkynes, alcohols to esters or acids, amines to nitros, nitroxides, or azo, alkenes to alcohols, carboxylic acids to CO₂, alcohols to ketones and aldehydes, akenes to ketones or aldehydes, alkenes to aldehydes and ketones, addition of halogens to double bonds, and aromatization. Many thousands of examples could be put forward which fit the definition.

Common examples of reductions include the reverse of the examples listed above. A common method of reduction is the addition of a hydrogen atom or hydride ion to organic species. Certain nucleophilic addition reactions, are deemed reductions because the mechanism involves the conversion of a double bond to a single bond.

Depending upon the chromophore that may be involved in the decolorization process, other mechanisms may be applied in the practice of the invention. The decolorization process is not necessarily effected by the heat process in the extruder. The decolorizing additive may be activated by another means, such as ultraviolet (UV) light or electron beams. The decolorizing additive may be triggered in the extruder, as previously described. In some applications the decolorizing additive may be triggered or activated at some later point in the process by several different means, including by the impingement of light having a certain predetermined wavelength upon the additive (agent).

### Oxidizing and Free Radical Generating Agents

One practice of the invention employs free radical generating compounds as decolorizing additives or agents. In such application, the free radical generating compounds could be, but is not limited to, organic peroxides, benzoins, azo compounds, aminoxyl compounds, or phosphorous-based photo-initiating compounds. Furthermore, the invention could in one embodiment be practiced using inorganic peroxides.

In the practice of the invention, a chemical structure, such as:
R₁—O—O—R₂

may be employed. This compound is a peroxide, which is a strong oxidizing agent. R₁ and R₂ may be independently selected from the following: hydrogens, alkyls, aryls, heteroaryls, acyls, silicon-containing groups, germanium containing groups, phosphorus-containing groups, titanium containing groups, organometallic compounds, carbonates, carbamates, and repeating units of a polymeric structure. R₁ and R₂ may also be joined in a cyclic structure.

In one particular practice of the invention, a peroxide compound may achieve decolorization of a colored polymer by several different mechanisms without being limited to any particular mechanism. It is believed that the peroxide may dissociate to form at least one radical. The resulting radical reacts with the chromophores in the colored polymer to decolorize or denature the chromophores under certain conditions when decolorization is desired.

It has been discovered that certain free-radical generating compounds (organic peroxides, benzoins, azo, and phosphorous-based photo-initiators, inorganic peroxides, aminoxyl compounds), when compounded with a colored resin react with the color and may completely remove essentially all of the color. Use rates of about 5000 ppm may be used, but significantly higher or lower amounts may be possible or necessary. Currently available products such as Lupersole 101 and Irgacure® 819 provide examples of the invention. In the case of high melt temperature polymers such as PET, it may be necessary to utilize highly thermally stable radical initiators such as silicon-peroxides. The cumyl-TMS peroxide (Compound 3 below) may be prepared for example as described in Buncel, et al. J. Chem. Society 1958, 1550-1555.

Some examples of peroxides, which can be used, are shown below. Organic and inorganic hydro peroxides are also within the scope of this invention. Many of the peroxide structures will be apparent to those skilled in the art, and other structures beyond those shown are clearly within the scope of the invention. Compound numbers provided below in connection with each structure correspond with compound numbers provided in the Tables herein.

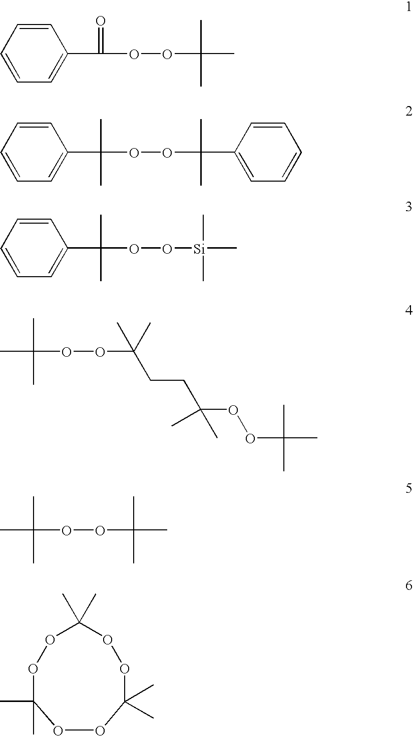

### Photochemical Radical Initiators

There are many photoinitiators which may be used as well in the practice of the invention. Many of these photo-initiators can function both as photo-initiators as well as thermally induced radical generators.

For example, it would be possible to lower the color level in a thermoplastic using methods of photochemical radical initiation, by heating the thermoplastic, mixing in a photochemical initiator, exposing the colored thermoplastic to light, and thereby decolorizing (partly or completely) at least some of the chromophores, thereby lowering the level of color exhibited by the thermoplastic.

Some structures are shown by way of example below.

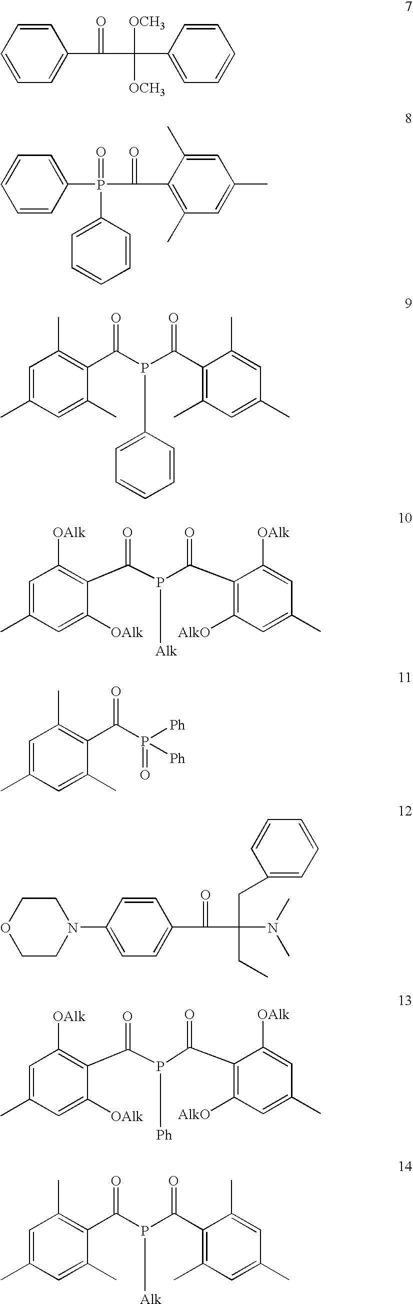

There are other radical generators, which can be used, as shown below.

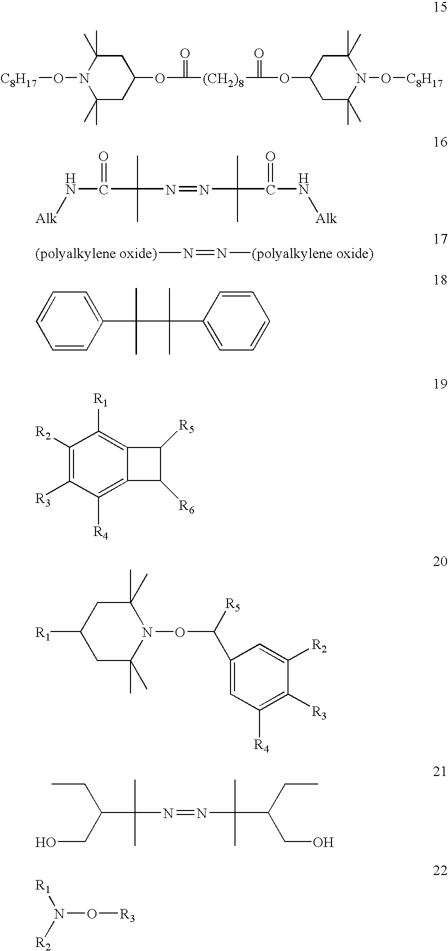

Other radical initiators have been disclosed in U.S. Pat. No. 6,620,892 and are hereby incorporated by reference.

### Reducing Agents

Additives that be employed in the practice of the invention as reducing agents in molten polymers may also be used as decolorization additives or agents. Examples of reducing agents include additives providing a source of hydride ion, hydrogen atom, or through nucleophilic attack eliminate the conjugated structure critical to chromophore function. Other reducing mechanisms that may be involved include metal reduction. Examples of reducing agents include but are not limited to metal hydrides and silanes. Sodium borohydride, lithium borohydride, potassium borohydride, lithium aluminum hydride, sodium triacetoxyborohydride, sodium cyanoborohydride, trialkylaluminum, thiourea dioxide, phosphoric, phosphinic or phosphorous compounds, bis(2-methoxyethoxy) aluminum hydride, and polymethylhydrosiloxane, many compounds with Si—H bonds, and others, may be employed in the practice of the invention.

### Colorant Types Employed in the Invention

Many different types of colorants or polymeric colorants may be used with the current invention. Colorants based on azo, methine, benzodifuranone, metal complexes, anthraquinone, and triphenyl methane chemistries and many others.

Polymeric colorants may be particularly useful. The following colorants, which are commercially available from Milliken Chemical of Spartanburg, S.C., USA may be employed in the practice of the invention: ClearTint® Red 464, ClearTint® Orange 496, ClearTint® Violet 480, ClearTint® Yellow 485, ReacTint® Blue X-17, ClearTint® PET Red 266. In examples involving decolorizing polypropylene, the color was typically added by way of a concentrate containing 0.5% colorant. In the case of PET, pre-colored resin was made by mixing the liquid color onto dried pellets and compounding on a singe-screw extruder.

### EXAMPLES

### Compounding for Making Pre-Colored PET Resin

Liquid colorant was blended via agitation onto a PET resin (in pellet form). The blend of colorant and pellets was gravity fed into the feed throat of the machine. PET resin was compounded on a Modern Plastic Machinery Corporation (MPM) single screw extruder with a screw diameter of 1.5 in and a length/diameter ratio of 24:1. In the feed section, melting was accomplished through the utilization of a heated screw extruder which rotated. The rotation of the screw provided thorough mixing of the colorant and molten resin together produced a uniform plastic melt which was extruded into strands, cooled in a water bath, and pelletized. The compounded resin was then thoroughly dried to ensure a water content less than about 50 ppm.

### Compounding for Decolorization of PET

Pre-colored or control PET resin was compounded on a 16 mm Prism co-rotating twin screw extruder with a length/diameter ratio of 25:1. The temperature set-points for the heaters for running all PET examples was 250° C. The decolorization additive was added to the process by either blending the additive onto the pellets and feeding the pellets into the hopper by agitation (21 in FIG. 1), pumping the additive directly into the hopper, or pumping the additive directing into the barrel of the extruder through a liquid line 29 into injection port 25. Average residence times on the extruder were no more than a few minutes. After leaving the extruder, the molten strands of polymer were cooled in a water bath and pelletized.

### Injection Molding PET Plaques

The PET resin, which had been compounded with the decolorization additive, was dried to a water level of less than 50 ppm and injection molded on an Arburg 220M-35-90 40-ton injection molding machine with a barrel temperature of 540-550° F. The pellets were gravity fed into the feed throat of the machine. In the feed section, melting was accomplished by utilization of a heated (heat transferred from the barrel of the machine) screw extruder, which rotated. The rotation of the screw provided thorough mixing of the colorant and molten resin together producing a uniform plastic melt which was injected into a mold in order to form the thermoplastic article, for instance a 2 inch by 3 inch plaque with a uniform thickness of 50 mils. The plaques were measured in both reflectance and transmittance on a Gretag-Macbeth Color-Eye 7000A Spectrophotometer for L*a*b*, and DE (CMC) and compared to control plaques.

### Coloring Polypropylene (PP) Resin

Polypropylene (“PP”) resins were colored by using ClearTint® masterbatch from Milliken and Company of Spartanburg, S.C., USA. A 0.5% masterbatch was used. The masterbatch was blended with uncolored resin using agitation before the mixture was fed into the hopper of the extruder used for decolorization.

### Compounding for Decolorization of PP

Polypropylene (PP) resins were compounded on a 16 mm Prism co-rotating twin screw extruder with a length/diameter ration of 25/1. After leaving the extruder, the molten strands of polymer were cooled in a water bath and pelletized. The decolorization additive was added to the process by blending the additive into pellets and feeding the pellets into the hopper by agitation (21 in FIG. 1), pumping the additive directly into the hopper, or by pumping the additive directing into the barrel of the extruder through a liquid line 29 into injection port 25. After leaving the extruder, the molten strands of polymer were cooled in a water bath and pelletized.

### Injection Molding PP Plaques

The PET resin, which had been compounded with the decolorization additive, was injection molded on an Arburg 221-75-350 40-ton injection molding machine with a barrel temperature of 210° C. The pellets were gravity fed into the feed throat of the machine. In the feed section, melting was accomplished through the utilization of a heated (heat transferred from the barrel of the machine) screw extruder which rotated. The rotation of the screw provided thorough mixing of the colorant and molten resin together producing a uniform plastic melt which was injected into a mold in order to form the thermoplastic article, for instance a 2 inch by 3 inch plaque with a uniform thickness of 50 mils. The plaques were measures in both reflectance and transmittance on a Gretag-Macbeth Color-Eye 7000A Spectrophotometer for L*a*b*, and DE (CMC) and compared to control plaques.

### Compression Molding

In some instances, the decolorized or control polymer was not pelletized upon exiting the decolorization extruder. Molten polymer was pressed by hand between two steel plates to make a patty about 1-2 inches in diameter and about 50 mil thick. This patty was quickly cooled in water and the color visually assessed.

### Examples 1-10

In the following examples, M&G 8006 PET resin, either uncolored or pre-colored (as indicated in the table below) was compounded on a 16 mm Prism co-rotating twin screw extruder with a length/diameter ratio of about 25:1. The temperature set points for the heaters for running all PET examples were 250° C. The decolorization additives were added to the process either by blending the additive into the pellets and feeding the pellets into the hopper by agitation (21 in FIG. 1), pumping the additive directly into the hopper, or pumping the additive directing into the barrel of the extruder through a liquid line 29 into injection port 25. After leaving the extruder, the molten strands of polymer were cooled in a water bath and pelletized.

Cumyl-TMS (compound 3) was synthesized according to literature procedure. Irgacure™ 369 (compound 12) was obtained from Ciba Specialty Chemicals. Phenylbis(2,4,6-trimethylbenzoyl)-phosphine oxide (compound 9) was obtained from Aldrich and was added as a 20% slurry in Tween™ 40. All loadings are for active ingredient.

The PET resin, which was compounded with the decolorization additive, was dried to a water level of less than about 50 ppm and injection molded on an Arburg 220M-35-90 40-ton injection molding machine, at a barrel temperature of 540-550° F. Plaques were made to a uniform thickness of about 50 mils. The plaques were measured in both reflectance and transmittance on a Gretag-Macbeth Color-Eye 7000A Spectrophotometer for L*a*b*, and Δ_{E(CMC)} compared to control plaques for each color. The L*a*b* numbers mathematically depict where a color falls in a standardized color space. The scale is widely accepted and is adequate to describe most colors. The ΔE_{(CMC)} is a measure of color difference. This measurement tells how different a color is from a control. The larger the magnitude of the number, the larger the color difference. For example, a red plaque that turned white would have a very large ΔE_{(CMC)}. A ΔE_{(CMC)} of 1 is considered to be at the edge of human perception.Color intensity is defined as the distance from the origin on the a* or b* axis. A greater positive or negative value indicates stronger colors.

TABLE 1
Color Data for Examples 1-10

| | | | Additive or | Additive | | | | |
|---|---|---|---|---|---|---|---|---|
| | | Color | Agent | (Agent) | | | | |
| | | loading | Compound | loading | | | | |
| Example | Color | (ppm) | Number | (ppm) | L* | a* | b* | ΔE_{CMC} |
| 1 | None | | | | 92.959 | −0.595 | 2.217 | |
| 2 | None | | 3 | 4000 | 92.163 | −0.935 | 5.23 | 3.891 |
| 3 | Red 266 | 400 | | | 37.463 | 33.825 | 0.754 | |
| 4 | Red 266 | 400 | 3 | 10000 | 82.328 | 6.932 | 31.37 | 36.887 |
| 5 | Violet 480 | 700 | | | 30.068 | 25.216 | −53.701 | |
| 6 | Violet 480 | 700 | 3 | 4500 | 83.36 | −1.002 | 18.92 | 53.422 |
| 7 | Red 464 | 700 | | | 56.869 | 46.385 | 34.725 | |
| 8 | Red 464 | 700 | 9 | 5000 | 54.121 | 0.999 | 15.194 | 24.383 |
| 9 | Red 464 | 700 | 3 | 5000 | 86.29 | −2.097 | 41.957 | 37.401 |
| 10 | Red 464 | 700 | 12 | 10,000 | 77.78 | 4.642 | 69.308 | 40.763 |

### Examples 11-15

In the following examples, PP resin (Basell 7525 RCP) uncolored or mixed with Milliken Chemical ClearTint® masterbatches were compounded on a 16 mm Prism co-rotating twin screw extruder with a length/diameter ration of 25/1. The temperature set points for the heaters were 195° C. in the throat section and 215° C. across the rest of the barrel. The decolorization additive was added to the process either by blending the additive onto the pellets and feeding the pellets into the hopper by agitation (21 in FIG. 1), by pumping the additive directly into the hopper, or by pumping the additive directing into the barrel of the extruder through a liquid line 29 into injection port 25. After leaving the extruder, the molten strands of polymer were cooled in a water bath and pelletized.

The compounded PP resin additive was injection molded on an Arburg 221-75-350 40-ton injection molding machine with a barrel temperature of 210° C., to form 2 inch by 3 inch plaques with a uniform thickness of 50 mils. The plaques were measured in both reflectance and transmittance on a Gretag-Macbeth Color-Eye 7000A Spectrophotometer for L*a*b*, and ΔE_{(CMC)} versus colored control plaques.

TABLE 2
Color Data for Examples 11-15

| | | | Additive | | | | | |
|---|---|---|---|---|---|---|---|---|
| | | Color | (Agent) | Additive | | | | |
| | | loading | Compound | loading | | | | |
| Example | Color | (ppm) | Number | (ppm) | L* | a* | b* | ΔE_{CMC} |
| 11 | None | | | | | | | |
| 12 | Red 464 | 700 | | | 52.024 | 48.158 | 24.34 | |
| 13 | Red 464 | 700 | 9 | 20,000 | 79.337 | −1.792 | 26.954 | 33.014 |
| 14 | Orange 496 | 700 | | | 67.619 | 35.467 | 72.67 | |
| 15 | Orange 496 | 700 | 9 | 10,000 | 88.175 | −2.008 | 14.488 | 27.173 |

### Examples 16-22

In the following examples, a titanium catalyzed PET resin, either uncolored or pre-colored (as indicated in the Table 3 below) was compounded on a 16 mm Prism co-rotating twin screw extruder with a length/diameter ration of 25:1. The temperature set-points for the heaters for running all PET examples were 250° C. The PMHS was added to the process by blending onto the pellets and feeding the pellets into the hopper by agitation. After leaving the extruder, the molten strands of polymer were cooled in a water bath and pelletized.

Polymethylhydrosiloxane (PMHS) which was used was obtained from Gelest Incorporated.

Compounded PET resins were dried to a water level of less than 50 ppm and injection molded on an Arburg 220M-35-90 40-ton injection molding machine, at a barrel temperature of 540-550° F. Plaques were made to a uniform thickness of 50 mils. Plaques were measured in both reflectance and transmittance on a Gretag-Macbeth Color-Eye 7000A Spectrophotometer giving values for L*a*b*, and ΔE_{(CMC)} versus to control plaques for each color.

TABLE 3
Color Data for Examples 16-22

| | | | | Additive | | | | |
|---|---|---|---|---|---|---|---|---|
| | | Color | | (Agent) | | | | |
| | | loading | Additive | loading | | | | |
| Example | Color | (ppm) | (Agent) | (ppm) | L* | a* | b* | ΔE_{CMC} |
| 16 | None | | | | | | | |
| 17 | Violet 480 | 700 | | | 39.616 | 17.541 | −46.322 | |
| 18 | Violet 480 | 700 | PMHS | 1500 | 82.718 | −0.903 | 21.05 | 49.460 |
| 19 | Orange 236 | 700 | | | 74.167 | 24.881 | 74.731 | |
| 20 | Orange 236 | 700 | PMHS | 2500 | 83.065 | −1.343 | 30.971 | 19.867 |
| 21 | Red 464 | 700 | | | 62.558 | 41.645 | 25.331 | |
| 22 | Red 464 | 700 | PMHS | 2500 | 82.902 | −1.568 | 23.552 | 29.632 |

### Examples 23-38

In the following examples, polypropylene (PP) resin (Basell 7525 RCP, uncolored or mixed with Milliken Chemical ClearTint Masterbatch) was compounded on a 16 mm Prism co-rotating twin screw extruder with a length/diameter ration of 25/1. Two temperature settings were used: temperature set points for the heaters were 195° C. in the throat section and 215° C. across the rest of the barrel. Some additives required a higher operating temperature of 260° C. Each decolorization additive was added to the process either by blending the additive into the pellets and feeding the pellets into the hopper by agitation (21 in FIG. 1), pumping the additive directly into the hopper, or pumping the additive directing into the barrel of the extruder through a liquid line 29 into injection port 25. After leaving the extruder, the molten strands of polymer were cooled in a water bath and pelletized.

Red-AI® was obtained from Aldrich as a 65 wt % solution in toluene. Sodium borohydride solution was obtained from Aldrich as a 2.0 M solution in triethylene glycol dimethyl ether. Ken-React® Lica 12 (Lica 12) was obtained from Kenrich Petrochemicals. Concentrations are listed in the table for the solution, not the active ingredient.

The compounded PP resins were injection molded on an Arburg 221-75-350 40-ton injection molding machine with a barrel temperature of 21 0C, to form 2 inch by 3 inch plaques with a uniform thickness of 50 mils. The plaques were measured in both reflectance and transmittance on a Gretag-Macbeth Color-Eye 7000A Spectrophotometer for L*a*b*, and ΔE_{(CMC)} versus colored control plaques.

TABLE 4
Data for Examples 23-38

| | | Color | | Additive | | | | |
|---|---|---|---|---|---|---|---|---|
| | | loading | Additive | loading | | | | |
| Example | Color | (ppm) | or Agent | (ppm) | L* | a* | b* | ΔE_{CMC} |
| 23 | None | | | | | | | |
| 24 | Blue X-17 | 700 | | | 47.906 | −8.312 | −49.805 | |
| 25 | Blue X-17 | 700 | Red-Al | 20,000 | 60.565 | 4.09 | 23.321 | 44.054 |
| 26 | Blue X-17 | 700 | PMHS + 10% | 9,300 | 66.016 | −1.191 | 21.247 | 42.523 |
| | | | Lica 12 | | | | | |
| 27 | Red 464 | 700 | | | 52.024 | 48.158 | 24.34 | |
| 28 | Red 464 | 700 | Red-Al | 11,000 | 88.518 | −1.706 | 7.154 | 29.408 |
| 29 | Red 464 | 700 | NaBH4 | 9,300 | 88.709 | −0.429 | 9.584 | 29.057 |
| | | | solution | | | | | |
| 30 | Red 464 | 700 | PMHS + 10% | 34,000 | 84.207 | 1.966 | 5.686 | 25.027 |
| | | | Lica 12 | | | | | |
| 31 | Red 266 | 400 | | | 35.401 | 32.284 | −13.32 | |
| 32 | Red 266 | 400 | NaBH4 | 15,000 | 86.298 | −0.757 | 15.29 | 38.89 |
| | | | solution | | | | | |
| 33 | Violet 480 | 700 | | | 27.869 | 27.932 | −56.747 | |
| 34 | Violet 480 | 700 | NaBH4 | 20,000 | 81.265 | 1.143 | 20.932 | 55.594 |
| | | | solution | | | | | |
| 35 | Violet 480 | 700 | NaBH4 | 8,500 | 84.681 | 1.099 | 15.166 | 53.6 |
| | | | solution | | | | | |
| 36 | Yellow 485 | 700 | | | 89.496 | −9.65 | 84.382 | |
| 37 | Yellow 485 | 700 | NaBH4 | 10,000 | 89.588 | −0.268 | 5.164 | 24.911 |
| | | | solution | | | | | |
| 38 | Yellow 485 | 700 | PMHS + 5% | 34,000 | 86.678 | −2.34 | 14.465 | 21.996 |
| | | | Lica 12 | | | | | |

### Examples 39-46

Photo-bleaching was carried out by compounding colored resin with photo-initiators on an extruder. Plaques were injected molded as described above. The plaques were subjected to light in a Xe Weatherometer for 40 h. The plaques containing photo-initiator were substantially decolorized by the light whereas the control plaques showed little change. Irgacure® 651 (7) was obtained from Ciba Specialty Chemicals.

TABLE 5
Data for Examples 39-46

| | | Color | | Additive | Light | | | | |
|---|---|---|---|---|---|---|---|---|---|
| | | loading | Additive | loading | exposure | | | | |
| Example | Color | (ppm) | or Agent | (ppm) | (h) | L* | a* | b* | ΔE_{CMC} |
| 39 | Red 464 | 700 | | | 0 | 56.029 | 46.649 | 32.442 | |
| 40 | Red 464 | 700 | 7 | 5,000 | 0 | 54.981 | 43.867 | 26.002 | 3.6 |
| 41 | Red 464 | 700 | | | 40 | 54.011 | 46.987 | 25.687 | |
| 42 | Red 464 | 700 | 7 | 5,000 | 40 | 65.594 | 32.338 | 27.431 | 9.49 |
| 43 | Red 266 | 200 | | | 0 | 46.001 | 44.897 | −17.878 | |
| 44 | Red 266 | 200 | 7 | 5,000 | 0 | 47.915 | 43.976 | −19.07 | 1.224 |
| 45 | Red 266 | 200 | | | 40 | 52.326 | 40.668 | −11.169 | |
| 46 | Red 266 | 200 | 7 | 5,000 | 40 | 69.408 | 19.791 | 30.305 | 27.532 |

### Example 47

Sixty grams of Paxon AD60-007 PE colored with 500 ppm of ClearTint® Violet 480 was melted in a Haake melt rheometer at 175° C. at a mixing speed of 25 rpm. To the molten polymer was added 2500 ppm of t-butylperoxybenzoate and the composition was mixed for ten minutes. The resulting polymer was decolorized.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

What is claimed is:

1. A method of substantially decolorizing a colored thermoplastic, the method comprising the steps of:
(a) providing a colored thermoplastic in solid form;
(b) heating said colored thermoplastic, said thermoplastic having chromophores within the thermoplastic that exhibit color;
(c) mixing said colored thermoplastic with an effective concentration of a decolorizing agent;
(d) heating or exposing to light said decolorizing agent with said chromophores in said colored thermoplastic;
(e) decolorizing at least some of said chromophores; and
(f) thereby forming a substantially decolorized thermoplastic.

2. An article made in part from said decolorized thermoplastic of claim 1.

3. The article of claim 2 wherein said article is a container.

4. A method of lowering the color intensity level in a colored thermoplastic by employing a decolorization agent, the method comprising the steps of:
(a) providing a colored thermoplastic in solid form;
(b) heating a colored thermoplastic, said thermoplastic having chromophores within the thermoplastic that exhibit color;
(c) mixing said colored thermoplastic with a decolorization agent;
(d) heating or exposing to light said decolorizing agent with said chromophores in said colored thermoplastic;
(e) decolorizing at least some of said chromophores; and
(f) lowering the level of color exhibited by said thermoplastic.

5. The method of claim 4 wherein said decolorization agent comprises a reducing agent.

6. The method of claim 4 wherein said decolorization agent comprises an oxidizing agent.

7. The method of claim 4 wherein said decolorization agent comprises a radical initiator.

8. The method of claim 5, wherein said reducing agent comprises a source of active hydrogen.

9. The method of claim 8, wherein said source of active hydrogen comprises a silicon hydride.

10. The method of claim 8 wherein said source of active hydrogen comprises a metal borohydride or metal hydride.

11. The method of claim 8 wherein said method further comprises providing a decolorization catalyst, said catalyst comprising at least one selected from the group consisting of: transition metals, Ti, Sn, Al, Be, Ga, Sb, Bi, and F ions.

12. The method of claim 11 wherein said decolorization catalyst comprises at least one acid or base selected from the group consisting of: Bronsted acids, Bronsted bases, Lewis acids and Lewis bases.

13. The method of claim 8 wherein said source of active hydrogen comprises an aluminum hydride.

14. The method of claim 8 wherein said source of active hydrogen comprises a hydrosiloxane.

15. The method of claim 6 wherein said oxidizing agent comprises the structure:
R₁—O—O—R₂
R₁ and R₂ being independently selected from the group consisting of: hydrogens, alkyls, aryls, heteroaryls, acyls, silicon-containing groups, germanium containing groups, phosphorus-containing groups, titanium containing groups, cyclic groups of R₁/R₂, organometallic compounds, carbonates, carbamates, and repeating units of a polymeric structure.

16. The method of claim 7 where said radical initiator comprises: 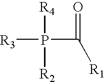
wherein R₁, R₂, R₃, and R₄ are independently selected from the group consisting of: hydrogen, alkyl, aryl, acyl, a nitrogen containing group, a phosphorous containing group, a silicon containing group, a metal containing group, esters, ethers, oxo, and peroxy.

17. A method of lowering the color intensity of a colored thermoplastic using an extruding mechanism, said method comprising the steps of:
(a) heating a colored thermoplastic, said thermoplastic having chromophores within the thermoplastic that exhibit color;
(b) mixing said colored thermoplastic with a decolorizing agent in an extruding mechanism;
(c) decolorizing said chromophores, thereby forming a thermoplastic having reduced color intensity levels; and
(d) extruding said thermoplastic.

18. The method of claim 17 wherein said thermoplastic comprises a polyester.

19. The method of claim 18 wherein said polyester comprises PET.

20. The method of claim 17 wherein said thermoplastic comprises a polyolefin.

21. The method of claim 17 wherein said decolorizing agent comprises a free radical generating compound.

22. The method of claim 21 wherein said free radical generating compound is selected from the group consisting of: organic peroxides, inorganic peroxides, benzoin compounds, azo compounds, aminoxyl compounds, and phosphorous-based photo-initiating compounds.

23. A method of lowering the color level in a thermoplastic using methods of photochemical radical initiation, said method comprising the steps of:
(a) heating a colored thermoplastic, said thermoplastic having chromophores therein that exhibit color;
(b) mixing with said colored thermoplastic with at least one photochemical radical initiator;
(c) exposing colored thermoplastic containing said photochemical radical initiator to light;
(d) decolorizing at least some of said chromophores; and
(e) lowering the level of color exhibited by said thermoplastic.

24. A method of substantially decolorizing a colored thermoplastic, the method comprising the steps of:
(a) heating said colored thermoplastic, said thermoplastic having chromophores within the thermoplastic that exhibit color;
(b) mixing said colored thermoplastic with a decolorizing agent for a period of time which is less than about two hours;
(c) heating said decolorizing agent with said chromophores in said colored thermoplastic;
(d) decolorizing said chromophores; and
thereby forming a substantially decolorized thermoplastic.

25. The method of claim 24 wherein said colored thermoplastic is provided in solid form prior to said heating step.

26. An article of manufacture made in part of decolorized thermoplastic made according to the method of claim 24.

27. An article of manufacture made in part of decolorized thermoplastic made according to the method of claim 25.

28. A colored composition comprising:
(a) a thermoplastic polymer;
(b) a colorant;
(c) a decolorizing agent, said decolorizing agent being adapted for reacting with at least one of said chromophores in reducing the color intensity level of said thermoplastic polymer.

29. The composition of claim 28, wherein said composition further comprises a decolorization catalyst, said catalyst being adapted for activation in reacting with said chromophore to reduce the color intensity of said colored composition.

30. An article made in part from the composition of claim 28.

31. An article made in part from the composition of claim 29.

32. The composition of claim 28 wherein said decolorization agent comprises a reducing agent.

33. The composition of claim 28 wherein said decolorization agent comprises an oxidizing agent.

34. The composition of claim 28 wherein said decolorization agent comprises a radical initiator.

35. The composition of claim 32, wherein said reducing agent comprises a source of active hydrogen.

36. The composition of claim 35, wherein said source of active hydrogen comprises a silicon hydride.

37. The composition of claim 35 wherein said source of active hydrogen comprises a metal borohydride or metal hydride.

38. The composition of claim 35 wherein said composition further comprises a decolorization catalyst, said catalyst comprising at least one selected from the group consisting of: transition metals, Ti, Sn, Al, Be, Ga, Sb, Bi, and F ions.

39. The composition of claim 38 wherein said decolorization catalyst comprises at least one acid or base selected from the group consisting of: Bronsted acids, Bronsted bases, Lewis acids and Lewis bases.

40. The composition of claim 35 wherein said source of active hydrogen comprises an aluminum hydride.

41. The composition of claim 28 wherein said source of active hydrogen comprises a hydrosiloxane.

42. The composition of claim 28 wherein said oxidizing agent comprises the structure:
R₁—O—O—R₂
R₁ and R₂ being independently selected from the group consisting of: hydrogens, alkyls, aryls, heteroaryls, acyls, silicon-containing groups, germanium containing groups, phosphorus-containing groups, titanium containing groups, cyclic compounds of R₁/R₂, organometallic compounds, carbonates, carbamates, and repeating units of a polymeric structure.

43. The method of claim 1 where said decolorizing agent comprises: 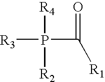
wherein R₁, R₂, R₃, and R₄ are independently selected from the group consisting of: hydrogen, alkyl, aryl, acyl, alkoxy, heteroaryl, phenoxy, substituted aromatic, a nitrogen containing group, a phosphorous containing group, a silicon containing group, a metal containing group, esters, ethers, oxo, acids, and peroxy.

44. A composition comprising a thermoplastic polymer and an inorganic peroxide.

45. The composition of claim 44 where the polymer has a melt processing temperature at least about 160° C.

46. The composition of claim 44 where the polymer has a melt processing temperature at least about 200° C.

47. The composition of claim 44 where the polymer has a melt processing temperature at least about 220° C.

48. The composition of claim 44 where the polymer has a melt processing temperature at least about 240° C.

49. The composition of claim 44 where the polymer is an aromatic polyester.

50. The composition of claim 44 where the polymer is polycarbonate.

51. The composition of claim 44 where the polymer is a polyolefin.

52. The composition of claim 44 where the polymer is PET.
